(19) United States
(12) Patent Application Publication
(10) Pub. No.: US 2007/0289395 A1
(43) Pub. Date: Dec. 20, 2007

(54) Device to determine an absolute rotation angle of a rotary shaft

(75) Inventor: Guido Hirzmann, Sailauf (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive safety systems GmbH

(21) Appl. No.: 11/820,458

(22) Filed: Jun. 19, 2007

(30) Foreign Application Priority Data
Jun. 20, 2006 (DE) 20 2006 009 621.3

(51) Int. Cl. G01B 7/30

(52) U.S. Cl. 73/865.9; 324/654; 324/679

(57) ABSTRACT

A device to determine an absolute rotation angle of a rotary shaft (14) has a first measurement arrangement (10) to measure a rotation angle in a restricted first measurement range, and a second measurement arrangement (12) to determine an absolute angle range. The first measurement arrangement (10) includes a rotor (16), coupled to the rotary shaft (14), and a carrier which is stationary in relation to the rotor (16). Coded zones (18) are arranged either on the rotor (16) or on the carrier. The coded zones (18) are distributed in the peripheral direction with respect to the rotary shaft (14). At least one first sensor (20) is arranged on the carrier or on the rotor (16), respectively. The first sensor (20) detects a coding of the coded zones (18) when the rotary shaft (14) rotates.

### TECHNICAL FIELD

The invention relates to a device to determine an absolute rotation angle of a rotary shaft.

### BACKGROUND OF THE INVENTION

In order to determine the absolute rotation angle of a steering wheel with respect to an original position (central position), a rotation angle measurement device is required, the measurement range of which is greater than 360°, because a steering wheel can carry out several revolutions in both directions of rotation. From German patent application DE 10 2005 043 301 A1 and German utility model DE 20 2005 001 887 U1 devices with a first measurement arrangement to measure a rotation angle in a restricted first measurement range, and a second measurement arrangement to determine an absolute angle range are known. The first measurement arrangement includes a rotor, coupled to the rotary shaft, and a carrier which is stationary in relation to the rotor. Those devices are suitable for an absolute rotation angle measurement. The first measurement arrangement measures the rotation angle in the range of 0° to 360°, the second measurement arrangement counts the half or full revolutions of the rotary shaft and thus indicates an absolute angle range (0°-180°, 180°-360° etc. or 0°-360°, 360°-720° etc.), in which the angle measured by the first measurement arrangement lies. The combination of the results of the two measurement arrangements then produces the absolute rotation angle of the rotary shaft with respect to the original position.

It is an object of the invention to provide a simply constructed and favourably priced device which is suitable for measuring an absolute rotation angle in a large measurement range.

### SUMMARY OF THE INVENTION

According to the invention, a device to determine an absolute rotation angle of a rotary shaft comprises a first measurement arrangement to measure a rotation angle in a restricted first measurement range, and a second measurement arrangement to determine an absolute angle range. The first measurement arrangement includes a rotor, coupled to the rotary shaft, and a carrier which is stationary in relation to the rotor. Coded zones are arranged either on the rotor or on the carrier. The coded zones are distributed in the peripheral direction with respect to the rotary shaft. At least one first sensor is arranged on the carrier or on the rotor, respectively. The first sensor detects the coding of the coded zones when the rotary shaft rotates. The coding has the advantage that a distinct angle can be determined at any time at least in the restricted first measurement range (generally 0° to 360°). This is particularly important in measuring the rotation angle of a steering wheel, because it is thereby ensured that information concerning the position of the steering wheel can be sought immediately after the vehicle electrical system is activated.

### BRIEF DESCRIPTION OF THE DRAWINGS

FIG. 1 shows a diagrammatic illustration of the first measurement arrangement of a device according to the invention; and

FIG. 2 shows a diagrammatic illustration of the second measurement arrangement of a device according to the invention.

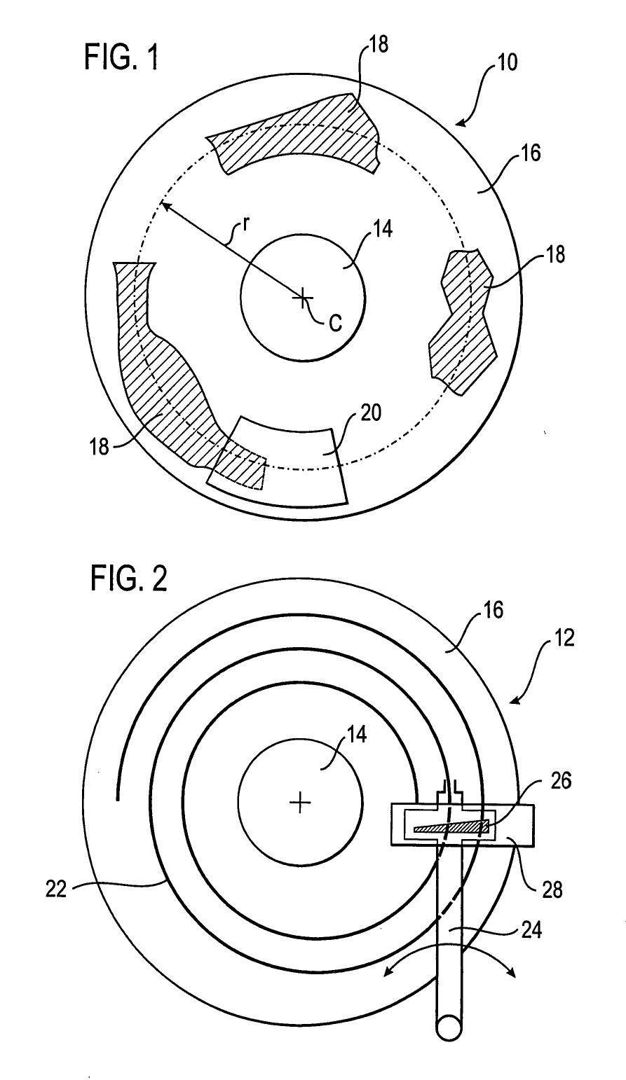

### DETAILED DESCRIPTION OF THE PREFERRED EMBODIMENTS

The combination of the measurement arrangements 10 and 12 illustrated in the Figures produces a device which is particularly suitable to determine the absolute steering wheel rotation angle in a motor vehicle. The steering wheel (not shown) is coupled non-rotatably to a rotary shaft 14 (steering column), which can carry out several revolutions in both directions of rotation, starting from an original position (central position of the steering wheel).

The first measurement arrangement 10 includes a rotor 16, which is coupled to the rotary shaft 14. For example, the rotor 16 is a disc which is connected non-rotatably to the rotary shaft 14 and oriented perpendicularly thereto. The rotor 16 has several coded zones 18. The coded zones 18 are electrically conductive zones which have different geometries and are arranged distributed in the peripheral direction approximately at the same radial distance r from the center of rotation C of the rotary shaft 12.

An inductive first sensor 20 is mounted approximately at the radial distance r from the rotation center C of the rotary shaft 12 on a carrier (not shown), which is stationary in relation to the rotor 16. The first sensor 20 is arranged and designed so that it detects the coding of the coded zones 18 when the rotary shaft 12 rotates, by measuring the inductivity of the coded zones 18 which are passing by.

The angle position of the rotor 18 is determined in a measurement range of 0° to 360° from the actually measured inductivity and/or from the inductivity change in an electronic evaluation arrangement.

In order to make an absolutely distinct measurement possible, the coding of the individual zones 18 is distinct at every location in the peripheral direction.

To increase the accuracy of measurement, a plurality of first sensors 20 can be provided, arranged at suitable different locations.

Instead of inductive first sensors 20, capacitive first sensors 20 may also be provided, by which a change in the capacity of the coded zones 18 can be detected. A combination of inductive and capacitive first sensors 20 is also conceivable.

It is basically also possible to realize the measurement principle described above in reverse, i.e. the first sensor or sensors 20 are mounted on the rotor 16 and the coded zones 18 are mounted on the stationary carrier.

The second measurement arrangement 12 likewise includes a rotor which is coupled to the rotary shaft 14. The rotor of the second measurement arrangement 12 may be identical to the rotor 16 of the first measurement arrangement 10 or, for example, may be a housing cover of the measurement device. For the sake of simplicity, it will be assumed below that the rotor is the same rotor 16 as used in the first measurement arrangement 10.

A spiral-shaped connecting link guide 22 is formed in the rotor 16. A deflection element 24 engages into the connecting link guide 22. The deflection element 24 undergoes a deflection which is dependent on the rotation of the connecting link guide 22. The deflection element 24 may, for example, be an arm which performs a rotary movement, or a slider which performs a linear movement.

The deflection element 24 also has at least one coded zone 26. The coded zone 26 of the deflection element 24 may again be an electrically conductive zone with a special geometry and/or may have sections of differing capacity.

The second measurement device 12 further includes a second sensor 28 which is arranged so as to be stationary in the deflection zone of the deflection element 24. The second sensor 28 is an inductive and/or capacitive sensor, coordinated with the coded zone 26 of the deflection element 24.

It is possible to detect the change in inductivity or capacity of the coded zone 26 with the second sensor 28. From this data, conclusions can be drawn by means of the evaluation electronics regarding the direction and number of revolutions which the rotary shaft 12 has carried out.

Several second sensors 28 may again be provided, arranged at suitable different locations, in order to increase the accuracy of measurement.

The second measurement arrangement 12 can analyse a sufficient number of revolutions (or portions thereof), in order to cover the entire rotation range of the steering wheel. The determining of the absolute steering wheel rotation angle then takes place by combining the measurement results of the first and second measurement arrangements 10 and 12.

The device according to the invention can check itself for plausibility by means of the evaluation electronics and is redundant. In addition, with the device according to the invention it is possible to maintain the detection of the angle to a limited extent, if one of the measurement arrangements fails, by means of the other measurement arrangement (which is still functionable), owing to the use of the two measurement arrangements 10, 12 which are designed to be continuous.

1. A device to determine an absolute rotation angle of a rotary shaft, the device comprising a first measurement arrangement to measure a rotation angle in a limited first measurement range, and a second measurement arrangement to determine an absolute angle range, the first measurement arrangement including a rotor, coupled to the rotary shaft, and a carrier which is stationary in relation to the rotor, coded zones being arranged on one of the rotor and the carrier, the coded zones being distributed in a peripheral direction with respect to the rotary shaft, at least one first sensor being arranged on the other of the rotor and the carrier, the first sensor detecting a coding of the coded zones when the rotary shaft rotates.

2. The device according to claim 1, wherein the coding is distinct at every location in the peripheral direction.

3. The device according to claim 1, wherein the coded zones are electrically conductive, the first sensor being an inductive sensor which detects the change in inductivity of the coded zones.

4. The device according to claim 1, wherein the coded zones have differing capacity, the first sensor being a capacitive sensor which detects the change in capacity of the coded zones.

5. The device according to claim 1, comprising a plurality of first sensors which are distributed in the peripheral direction.

6. The device according to claim 1, wherein the second measurement arrangement includes a rotor coupled to the rotary shaft, a spiral-shaped connecting link guide arranged on the rotor, and a deflection element which engages into the connecting link guide and undergoes a deflection dependent on a rotation of the connecting link guide.

7. The device according to claim 6, wherein the second measurement arrangement further comprises at least one second sensor, the deflection element having at least one coded zone, the second sensor detecting the coding of the coded zone of the deflection element when the deflection element deflects.

8. The device according to claim 7, wherein the coded zone of the deflection element is electrically conductive, the second sensor being an inductive sensor which detects the change in inductivity of the coded zone.

9. The device according to claim 6, wherein the coded zone of the deflection element has sections of differing capacity, the second sensor being a capacitive sensor which detects the change in capacity of the coded zone of the deflection element.

10. The device according to claim 6, comprising a plurality of second sensors which are distributed in the deflection range of the deflection element.
